(19) United States
(12) Patent Application Publication
(10) Pub. No.: US 2009/0160531 A1
(43) Pub. Date: Jun. 25, 2009

(54) MULTI-THRESHOLD VOLTAGE-BIASED CIRCUITS

(75) Inventors: Oscar Law, Markham (CA); Changyok Park, North York (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/960,972

(22) Filed: Dec. 20, 2007

(51) Int. Cl. G05F 1/10

(52) U.S. Cl. 327/534

(57) ABSTRACT

A circuit and a method of operation to reduce dynamic and static power dissipation in the circuit are disclosed. The circuit is multi-threshold, voltage-biased and includes a p-channel field effect transistor (FET) and an n-channel FET. A source terminal of the p-channel FET interconnects to a higher-voltage rail of a power supply and a source terminal of the n-channel FET interconnects to a lower-voltage rail of the power supply. At least one of the FETs includes a back contact. The circuit may be operated by applying a fixed bias voltage to the back contact. The fixed bias voltage is independent of the power supply voltage which may be varied. In a normal state, the supply voltage is adjusted to decrease dynamic power consumption. In a low power state, the supply voltage is further adjusted to limit leakage current. The circuit may optionally include a second fixed biasing voltage source so that both FETs are biased.

### FIELD OF THE INVENTION

The present invention relates generally to power reduction in circuits, and more particularly to using multiple-threshold voltage biased circuits to reduce power consumption.

### BACKGROUND OF THE INVENTION

Power is a limited resource in electronic devices. This is particularly true of battery operated mobile devices. Many modern circuit designs thus attempt to reduce power consumption and prolong battery life, particularly in mobile devices. Furthermore, power consumption is closely associated with heat dissipation in integrated circuits. Excessive power consumption and its dissipation in the form of heat may damage circuit components and render electronic devices inoperable. It is therefore desirable to reduce the amount of power dissipated in electronic devices. Power dissipation can be effectively reduced by limiting power consumption whenever possible.

There are two types of power consumption in electronic circuits called dynamic (or active) power consumption, and static (or leakage) power consumption. Dynamic power consumption is caused primarily by switching logic and the associated charging and discharging of capacitors. In contrast, static power dissipation is primarily caused by leakage current. Thus static power dissipation may take place even when the inputs to a given circuit may remain unchanged. In other words, even if a given circuit is not actively switching, static power dissipation takes place as a result of leakage current.

One way to mitigate static power dissipation in circuits is to use transistors with a high threshold-voltage. Threshold-voltage, in a field-effect-transistor (FET) such as a metal oxide semiconductor (MOS) FET, refers to the minimum gate-to-source voltage required to turn the transistor on, so that current flows between the source and the drain terminals.

For example, in complementary metal oxide semiconductor (CMOS) logic, an inverter is formed by placing a p-type transistor (also called p-channel FET or PMOS transistor) and an n-type transistor (also called n-channel FET or NMOS transistor) in series with their gate terminals interconnected to a common input and their drain terminals connected together to provide an output. An input voltage associated with logic high turns the NMOS FET on while the PMOS FET is off. Similarly an input voltage associated with logic low turns the PMOS FET on while the NMOS FET is off.

As can be appreciated, if low threshold transistors are used, more leakage current may flow through the transistor. Moreover, a transient voltage at the common input may easily turn on both transistors which would cause current to flow and thereby increase static power dissipation. Low threshold transistors are more easily turned on, as the voltage level that transient voltages must attain relatively low. On the other hand, a high threshold transistor requires that any transient voltage input attain a voltage level that is relatively high, before turning on.

Unfortunately, high threshold transistors negatively impact signal propagation in circuits. High threshold transistors cannot be turned on and off as fast as low threshold devices. This is because signals require a finite time to rise/fall above/below the required voltage threshold level to turn on/off the transistors and thus the required time increases with increasing threshold values. Moreover, the output current of a high-threshold transistor is typically lower than that of a low threshold one, and thus a high threshold transistor takes a longer time to charge up a capacitive load.

Therefore, low threshold transistors are typically used when signal propagation speed is the dominant consideration. However, low threshold transistors tend to suffer from high leakage current and therefore consume relatively large amounts of static power.

Accordingly there is a need for a circuit design that reduces both dynamic power consumption and static power dissipation without introducing undue signal propagation delay.

### SUMMARY OF THE INVENTION

In accordance with one aspect of the present invention there is provided, a method of operating an integrated circuit. The circuit includes at least one p-channel field effect transistor (FET) and an n-channel FET formed in a substrate. Each of the p-channel FET and n-channel FET include a gate, a source, and a drain. At least one of the FETs further includes a back contact in the substrate. The drain of the p-channel FET interconnects the drain of the n-channel FET. The method includes providing a fixed bias voltage to the back contact to bias a body of the FET with the back contact. The method also includes applying a supply voltage independent of the fixed bias voltage to the source of the FET with the back contact at a first voltage level when the circuit is in a normal state. The method also includes applying the supply voltage at a second voltage level when the circuit is in a low power state. The second voltage level is lower than the first level when the FET with the back contact is the p-channel FET and higher than the first level when the FET with the back contact is the n-channel FET. Adjusting the supply voltage helps limit leakage current between the source of the p-channel FET and the source of the n-channel FET.

In accordance with another aspect of the present invention, there is provided, a method of operating an integrated circuit that includes a p-channel field effect transistor (p-channel FET) and n-channel FET formed in a substrate. Each of the p-channel FET and n-channel FET has a gate, a source, and a drain terminal. The p-channel FET further includes a back contact in the substrate. The drain of the p-channel FET interconnects the drain of the n-channel FET. The method includes providing a fixed bias voltage to the back contact of the p-channel FET to bias a body of the p-channel FET; applying a supply voltage independent of the fixed bias voltage to the source of the p-channel FET at a first voltage level when the circuit is in a normal state; and applying the supply voltage at a second voltage level lower than the first voltage level when the circuit is in a low power state so as to limit leakage current between the source and the drain of the p-channel FET.

In accordance with another aspect of the present invention, there is provided, a method of operating an integrated circuit. The circuit includes: an n-channel field effect transistor (n-channel FET) and a p-channel FET formed in a substrate. Each of the n-channel FET and p-channel FET includes a gate, a source, and a drain. The n-channel FET further includes a back contact in the substrate. The drain of the n-channel FET interconnects the drain of the p-channel FET. The method includes: providing a fixed bias voltage to the back contact of the n-channel FET to bias a body of the n-channel FET; applying a voltage independent of the fixed bias voltage to the source of the n-channel FET at a first voltage level when the circuit is in a normal state. The method also includes applying the voltage applied to the source of the n-channel FET at a second voltage level higher than the first voltage level when the circuit is in a low power state so as to limit leakage current between the drain and the source of the n-channel FET.

In accordance with another aspect of the present invention, there is provided, a circuit including a p-channel field effect transistor (FET) formed in an n-well of a p-type substrate, an n-channel FET formed in a p-well, an adjustable power supply and a biasing voltage source. The adjustable power supply is in communication with a higher-voltage rail interconnecting the source of the p-channel FET and a lower-voltage rail interconnecting the source of the n-channel FET. The biasing voltage source proves a fixed biasing voltage to the back contact of the p-channel FET. The p-channel FET includes a gate, source, drain and a back contact for biasing the n-well. The p-well is formed inside a deep n-well in the substrate, the n-channel FET includes a gate, source, and drain terminals. The gate of the n-channel FET interconnects the gate of the p-channel FET and the drain of the n-channel FET interconnects the drain of the p-channel FET.

In accordance with yet another aspect of the present invention there is provided a device including an integrated circuit, a first bias voltage source, and an adjustable supply voltage source. The integrated circuit includes a p-channel field effect transistor (FET), with gate, source, drain and back contact terminals formed in a substrate. The first bias voltage source provides a first fixed bias voltage to the back contact. The adjustable supply voltage source is interconnected to the source terminal to provide a supply voltage independent of the first bias voltage. The device is operable in a normal state and a low power state. In the normal state the supply voltage source provides the supply voltage at a first voltage level; and in the low power state the supply voltage source provides the supply voltage at a second voltage level, lower than the first level, so as to limit leakage current through the p-channel FET in the low power state.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a schematic diagram of a conventional CMOS inverter circuit including a PMOS transistor and an NMOS transistor;

FIG. 2 is a schematic diagram of a device exemplary of an embodiment of the present invention including a circuit with a controllable power supply;

FIG. 3 is a schematic diagram of an inverter circuit exemplary of an embodiment of the present invention in which a biasing voltage separate from the power supply is applied to the body of the p-channel FET;

FIG. 4 is a schematic diagram of an inverter circuit exemplary of an embodiment of the present invention, in which a biasing voltage separate from the power supply is applied to the body of the n-channel FET;

FIG. 5 is a schematic diagram of an inverter circuit, exemplary of an embodiment of the present invention, in which a separate biasing voltage is provided the body of the n-channel FET and another biasing voltage is provided to the body of the p-channel FET; and

FIG. 6 is a cross-sectional view of a triple-well structure for the inverter circuit of FIG. 5 formed in a semiconductor substrate.

### DETAILED DESCRIPTION

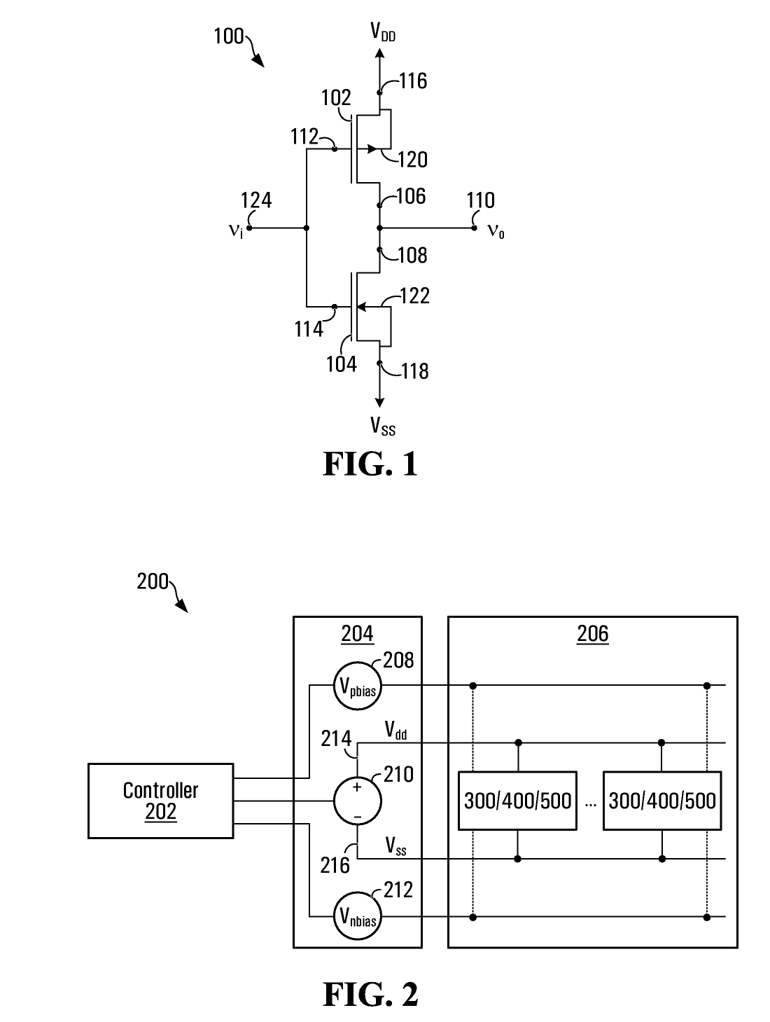

FIG. 1 is a schematic diagram of a conventional CMOS inverter circuit 100 including a PMOS transistor 102 interconnecting an NMOS transistor 104. A drain terminal 106 of PMOS transistor 102 is interconnected to drain terminal 108 of NMOS transistor 104 to form an output node 110. Gate terminal 112 of NMOS transistor 104 interconnects gate terminal 114 of PMOS transistor 104 to form a common input node 124.

A back contact 120 and a source terminal 116 of PMOS transistor 102 are connected together so that the body of transistor 102 is at the same voltage as source terminal 116. Back contacts refer to the substrate body or the bulk of a transistor, which may be considered as a fourth terminal. The higher-voltage rail of a power supply (providing voltage V_{DD}) is connected to both source terminal 116 and back contact 120 of PMOS transistor 102. V_{DD} may be 1V.

A back contact 122 and a source terminal 118 of NMOS transistor 104 are similarly interconnected together so that they are at the same voltage. The lower-voltage rail of a power supply (at a voltage level of V_{SS}) interconnects source terminal 118 and back contact 122 of NMOS transistor 104. V_{SS} may be 0V.

In operation, conventional inverter circuit 100, accepts a digital input voltage (high or low) at input node 124 and outputs the complement of the input voltage (low or high respectively), at its output node 110. A voltage level of high supplied at input node 124 causes the voltage level at its output node 110 to be low. Conversely, a voltage level of low at input node 124 causes output node 110 to be high. Typically, the higher voltage-rail voltage V_{DD} and the lower voltage-rail voltage V_{SS} are used to represent digital highs and lows, respectively.

In circuit 100, only one of the transistors is on (i.e., conducts) when the input voltage is high or low. When the input signal at input node 124 is high, PMOS transistor 102 turns off while NMOS transistor 104 turns on, allowing current to flow. As the electrical resistance of NMOS transistor 104 is very low when it is turned on, output node 110 simply reflects voltage V_{SS} at source terminal 118. On the other hand, when the input signal at input node 124 is set low, PMOS transistor 102 turns on while NMOS transistor 104 turns off preventing current from flowing from drain terminal 108 to source terminal 118. As the electrical resistance of a PMOS transistor is also very low when in the transistor is fully turned on, output node 110 reflects the high-voltage power supply rail voltage V_{DD}.

As can be appreciated, transistors 102, 104 may be turned on or off depending on the input voltage at their gate terminal. Specifically, a CMOS transistor can only be turned on, if the voltage difference between its gate and source terminals exceeds its threshold voltage. The threshold voltage of a field-effect-transistor refers to the gate-to-source voltage required to turn the transistor on, so as to allow current to flow between the source and the drain terminals.

For convenience, a threshold-voltage of a p-channel FET is denoted Vₜₚ while a threshold-voltage of an n-channel FET is denoted Vₜₙ. Thus, for NMOS transistor 104 for example, if the gate-to-source voltage V_{gs} is below its threshold voltage Vₜₙ (that is, if V_{gs}<Vₜₙ) the transistor is turned off. Conversely if V_{gs}>Vₜₙ then transistor 104 is turned on and current flows from drain to source. For PMOS transistor 102 Vₜₚ is negative, and the source-to-gate voltage must exceed |Vₜₚ| to turn on PMOS transistor 102 (that is, PMOS transistor 102 turns on only if V_{gs}<Vₜₚ).

Of note, any floating input in the range {Vₜₙ<Vᵢ<V_{DD}−|Vₜₚ|} at node 124, would turn both transistors 102, 104 on. This is because the conditions (V_{gs}<Vₜₚ for PMOS transistor 102); and (V_{gs}>Vₜₙ for NMOS transistor 104), may both be satisfied by an input voltage Vᵢ in this range.

In any given CMOS circuit, it is generally desirable to reduce the total power consumption to conserve power and reduce gate delays to speed up circuit operation. Total power consumption includes dynamic power consumption and static power dissipation.

Dynamic power consumption in circuit 100 results from each low-high-low transition of a signal at input node 124, charging a load at output node 110 roughly to V_{DD}, and then discharging it to roughly V_{SS} volts. If charge store at a load interconnecting node 110 is approximated with a linear capacitor C, the energy dissipated in charging it from V_{SS} to V_{DD} is ½C(V_{DD}−V_{SS})². The amount of energy stored on a load at node 110 is thus ½C(V_{DD}−V_{SS})². This amount of energy is also the amount dissipated when the load is discharged, so in one cycle the total energy dissipated is

E=1½C(V_{DD}−V_{SS})²+½C(V_{DD}−V_{SS})²+½=C(V_{DD}−V_{SS})².

If the input signal at node 124 is operating at a frequency of f, the average dynamic power consumption P_{dynamic} is f times the total energy or

P_{dynamic}=fC(V_{DD}−V_{SS})² [1]

Static power dissipation, which is also a major source of power consumption, is caused primarily by leakage current. While ideally no current flows between the drain and source terminals of a transistor when it is turned off, in a real transistor a small amount of current (called leakage current) flows even when gate voltage is below the threshold voltage. Unfortunately leakage current increases substantially when low threshold transistors (that is, transistors with low values for |Vₜₚ|, Vₜₙ) are used.

The relationship between leakage current I_{DS}, V_{gs} and threshold voltage Vₜₙ for an NMOS transistor is shown in equation [2] below. Leakage current I_{DS}, which flows from drain to source in an NMOS transistor, increases exponentially with (V_{gs}−Vₜₙ).

$${I}_{DS} = {I}_{{DS}_{0}} {e}^{\frac{{v}_{gs} - {v}_{tn}}{{nv}_{thermal}}} ( 1 - {e}^{\frac{- {v}_{ds}}{{v}_{thermal}}} ) \qquad [ 2 ]$$

where I_{DS}_{₀} is the leakage current when V_{gs}=Vₜₙ; Vₜₕₑᵣₘₐₗ is the thermal voltage, V_{ds} is the source-to-drain voltage and n is constant determined by the device physical characteristics of the transistor. As would be expected, the equation indicates that no leakage current would flow if the source and drain are at same voltage (i.e., if V_{ds}=0V).

It can be seen that use of low threshold transistors may cause fairly significant leakage current to flow and thus lead to increased static power dissipation. Thus the use of high threshold voltages may reduce static power dissipation in circuit 100.

Threshold voltages Vₜₚ, Vₜₙ also affect the delay of logic gates (such as an inverter). Delay in a logic gate is a function of the supply voltage and the threshold voltages of its internal transistors. In particular, if |Vₜₚ|=Vₜₙ and under typical transistor device geometries, the delay Δt through an inverter is roughly inversely proportional to (V_{DD}−|Vₜₚ|)². That is,

Δt=KV_{DD}/(V_{DD}−|Vₜₚ|)² where K is a constant. [3]

Thus, for a given supply voltage, a lower threshold value leads to faster switching of an inverter output in response to a change in the logic level of its input. Of course, this allows faster CMOS circuits with very small propagation delay in logic gates formed from low threshold transistors.

As should now be apparent dynamic power consumption, static power dissipation and gate delay in circuit 100 are closely interrelated. Low power supply voltage leads lower dynamic power consumption but also introduces delays. Low threshold transistors reduce gate delays but increase leakage current leading to increased static power dissipation and high threshold transistors reduce leakage current but increase gate delays.

FIG. 2 illustrates a device 200, exemplary of an embodiment of the present invention. Device 200 may contain a controller 202, a circuit 206 and a controllable power supply 204. As detailed below, circuit 206 may also be formed of inverter circuits 300, inverter circuits 400, or inverter circuits 500. As will be seen, inverter circuits 300, 400, 500 overcome some of the trade-offs noted above. As will be appreciated however, inverter circuits 300, 400, 500 are only exemplary, and intended to illustrate basic operations.

Power supply 204 may include a p-channel FET biasing voltage source 208, and an n-channel FET biasing voltage source 212. Power supply 204 also includes supply voltage source 210 providing a voltage V_{dd} to a higher-voltage rail 214 and a voltage Vₛₛ to a lower-voltage rail 214.

Device 200 may be any one of a number of electronic devices such as a desktop or a laptop computing device, personal digital assistant (PDA), a digital music player, a digital camera, a video graphics card, a cell-phone or the like; or a component thereof. Controller 202 may be a control circuit which may include a direct or a feedback control loop, or a general purpose microcontroller. Power supply 204 may be a controllable power supply capable of outputting different voltages in response to control settings provided by controller 202. Circuit 206 is operable in a normal (high power) state, and a low power state.

As will be apparent, controller 202 may place circuit 206 in a low power state (also called sleep mode or standby mode), by reducing the supply voltage provided by power supply source 210 from V_{dd} to V′_{dd} (that is, V′_{dd}<V_{dd}<V_{pbias}). In one specific embodiment, voltage levels of V′_{dd}=0.5V; V_{dd}=0.9V and V_{pbias}=1.0V may be used. Controller 202 may of course, take the CMOS circuit out of its low power state (i.e., awaken it from sleep mode) and return it to a normal state as needed. As low-threshold transistors would be used in circuit 206, dynamic power dissipation may be reduced without performance degradation.

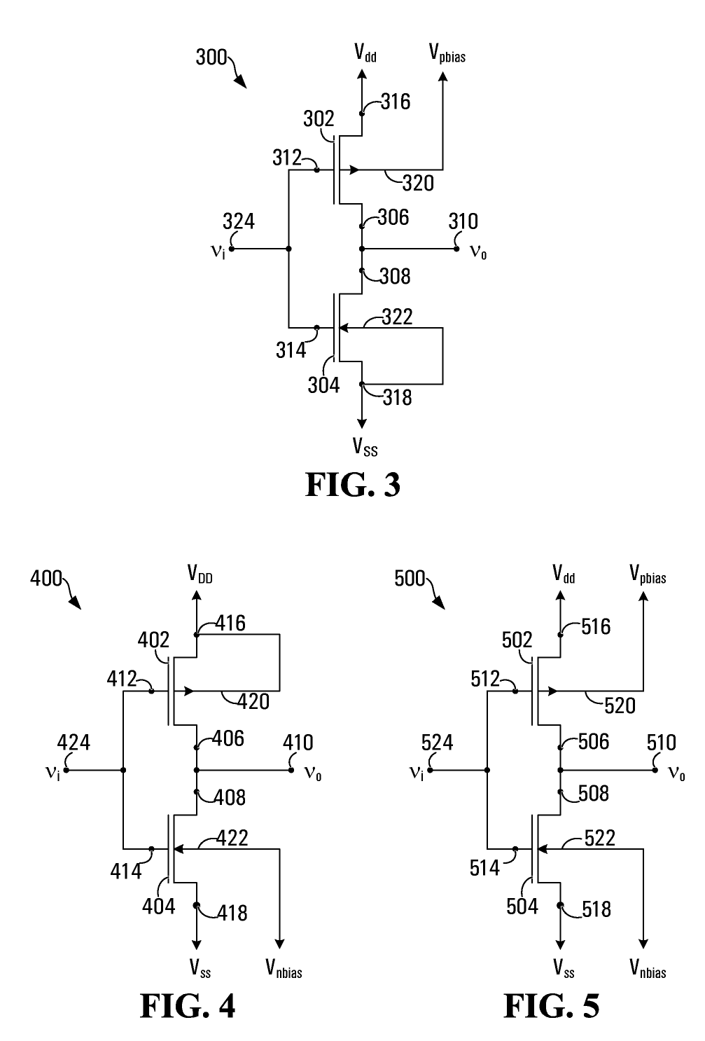

FIG. 3 schematically illustrates an exemplary inverter circuit 300, which forms part of device 200. Inverter circuit 300 may be a CMOS circuit. Inverter circuit 300 includes p-channel FET 302. A drain terminal 306 of p-channel FET 302 is interconnected to a drain terminal 308 of an n-channel field effect transistor 304 to form an output node 310. A gate terminal 312 of p-channel FET 302 interconnects a gate terminal 314 of n-channel FET 304 to form a common input node 324.

A back contact 320 of p-channel FET 302 is connected to an independent biasing voltage source (e.g., biasing voltage source 208 in FIG. 2) providing a fixed biasing voltage V_{pbias}. Back contact 320 may be in electrical communication with a well inside a substrate in which FET 302 is formed.

A source terminal 316 of p-channel FET 302 is similarly interconnected to an independently adjustable supply voltage source providing a supply voltage V_{dd}. A back contact 322 of n-channel FET 304 interconnects to a source terminal 318 of the same n-channel FET 304. Both source terminal 318 and back contact 322 of n-channel FET 304 interconnect a lower-voltage rail of a power supply providing a voltage level V_{SS}. The voltage level V_{SS} may be at electrical ground (e.g., V_{SS}=0V in this example).

In operation, inverter circuit 300, accepts a voltage representative of a digital logic value at its input node 324 and outputs a voltage level at its output node 310, representative of the complement or inverse of the input logic. A voltage level associated with logic high, supplied at input node 324 thus causes the voltage level at output node 310 to correspond to logic low. Conversely, a voltage level corresponding to logic low at input node 324 causes output node 310 to have a voltage level corresponding to logic high. Again, the higher voltage-rail voltage V_{dd} and the lower voltage-rail voltage V_{SS} may be used to represent digital highs and lows, respectively.

To reduce dynamic power consumption, applied voltage level V_{dd} may be set lower than the corresponding voltage level in conventional circuits (such as circuit 100). In other words, the power supply voltage V_{dd} provided to source terminal 316 of FET 302 in a normal state, may be lower than the power supply voltage V_{DD} used in conventional circuit 100 (i.e., V_{dd}<V_{DD}).

Back contact 320 of p-channel FET 302 is supplied with an independent, fixed biasing voltage V_{pbias}. Back contact 320 may be at a voltage potential higher than the voltage V_{dd} of source terminal 316 (i.e., V_{dd}<V_{pbias}). For example, the supply voltage may be about 0.9V (i.e., V_{dd}≈0.9V), while the biasing voltage V_{pbias} may be 1.0V (i.e., V_{pbias}=1.0V).

Advantageously, the range of undesirable input voltage values of Vᵢ which may turn on both FETs 302, 304 in circuit 300, and thus permit current to flow, becomes narrower as the supply voltage V_{dd} is reduced. Recall that in circuit 100 any floating input in this range {Vₜₙ<Vᵢ<V_{DD}−|Vₜₚ|}, would turn both transistors 102, 104 on. However, this range for circuit 300 is a narrower range {Vₜₙ<Vᵢ<V_{dd}−|Vₜₚ|=0.9V−|Vₜₚ|}.

Conveniently, as the supply voltage V_{dd} is now reduced, (and digital highs and lows are now represented by smaller voltages) p-channel FET 302 may be a chosen to have a lower |Vₜₚ|. Advantageously, a lower threshold voltage |Vₜₚ| improves the switching speed (or reduce the gate delay) in circuit 300. The range may vary depending on the fabrication process technology used. Moreover, as the supply voltage V_{dd} is reduced, dynamic power consumption is also correspondingly reduced.

In addition to propagation delays and dynamic power consumption, static power dissipation is also an important concern. When inverter circuits 300 are not actively switching, power consumption is due primarily to static power dissipation caused by leakage current. This situation may typically arise when inputs to a digital device such as device 200, do not change for a period of time, such as when a wireless telephone connection to a cell phone terminates; an application running on a PDA is stopped; no interface inputs (e.g. from keyboard, mouse, button, touchpad etc.) are provided to a device (e.g. laptop, PDA, calculator, etc.) for some duration; video playback is stopped in a video player device, or the like. Upon detecting such inactivity, controller 202 may place circuit 206 (and thus inverter circuits 300) in a low power state by reducing the supply voltage provided by power supply source 210 to V′_{dd}.

Advantageously, circuit 206 may be operated so as to reduce static power dissipation. As noted above, in conventional circuits, the use of low threshold transistors leads to increased leakage current and thus increases static power dissipation. For example, if low threshold transistors are used in circuit 100 then leakage current and static power dissipation may increase dramatically.

However, as will become apparent, lowering the voltage at source terminal 316 relative to the voltage of body contact 320 (V_{pbias}) increases the effective threshold voltage of FET 302 by introducing a reverse bias. This increase in the effective threshold voltage of FET 302 limits leakage current from source terminal 316 to drain terminal 306 as suggested in equation [2]. Thus reducing the voltage provided to source terminal 316 to V′_{dd} while maintaining the fixed biasing voltage V_{pbias} supplied to the body of FET 302 when circuit 300 is in a low power state, reduces static power dissipation. In one embodiment, in a low power state, voltage supplied to source terminal 316 may be reduced to about V′_{dd}≈0.5V which is higher than Vₜₚ while back contact 320 is maintained at V_{pbias}≈1.0V to reduce leakage current. A potential difference between V_{pbias} and V′_{dd} that is larger than about 0.7V may prevent parasitic diodes from turning on.

Conveniently, although the higher-voltage rail source terminal 316 is at a reduced voltage level, V′_{dd} when circuit 206 is in its low power state, output nodes of its inverters (i.e., node 310 of inverter circuit 300) may maintain their output logic to preserve their state.

An added benefit of placing each circuit 300 in a low power state as described above is that, it is the supply voltage which is adjusted (from V_{dd}=0.9V to V′_{dd}=0.5V), rather than the body biasing voltage—which remains fixed at V_{pbias}=1.0V. The supply voltage is delivered through the higher-voltage rail, which presents much less impedance than the substrate body. Metal interconnects have low sheet resistance typically ranging from tens to hundreds of milliohms. On the other hand, the substrate may have a sheet resistance in the range of hundreds to thousands of ohms. As a result, less power is dissipated in adjusting the supply voltage (between V_{dd} and V′_{dd}) instead of adjusting the body biasing voltage V_{pbias} which remains fixed.

An alternate embodiment of an inverter may have a back contact of its p-channel FET interconnected to a source terminal of the p-channel FET, while a back contact of its n-channel FET may be interconnected to a separate biasing voltage source providing a fixed biasing voltage. A biasing voltage source, separate from the lower-voltage power supply rail (which may be ground) interconnecting the source terminal of the n-channel transistor, may be used.

Accordingly, FIG. 4 shows an inverter circuit 400 exemplary of another embodiment of the present invention. Inverter circuit 400 includes a p-channel FET 402 interconnecting an n-channel FET 404. Drain terminal 406 of p-channel FET 402 is interconnected to the drain terminal 408 of the n-channel FET 404 to form the output node 410. Gate terminal 412 of p-channel FET 402 and interconnects gate terminal 414 of n-channel FET 404 to form a common input node 424. Source terminal 416 of p-channel FET 402 is interconnected to a supply voltage source providing supply voltage V_{DD}.

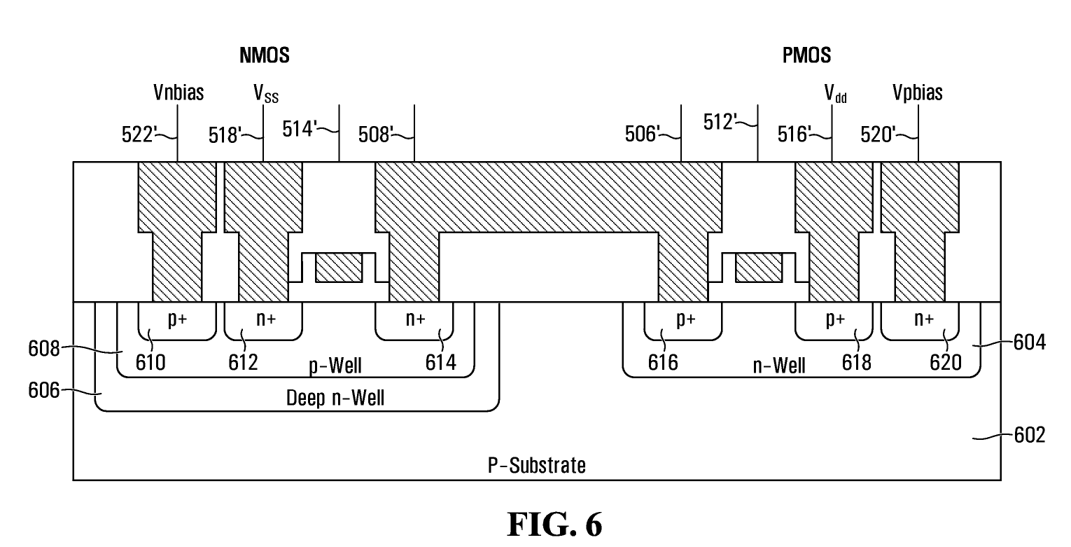

Back contact 422 of n-channel FET 404 is interconnected to an independent biasing voltage source (e.g., biasing voltage source 212 in FIG. 2) providing a fixed biasing voltage V_{nbias}, while source terminal 418 of n-channel FET 404 interconnects the lower-voltage rail of a power source (e.g. power source 210 in FIG. 2) providing a voltage of Vₛₛ. However, back contact 420 of p-channel FET 402 may be interconnected to its own source terminal 416. Circuit 400 may be formed as a triple-well structure such as that depicted in FIG. 6. As may be appreciated, in a triple-well structure, an n-channel FET may be formed in a p-well, which may itself be formed inside a deep n-well within a p-type substrate.

Back contact 422 may be at a voltage potential lower than the voltage at source terminal 418 (i.e., V_{nbias}<Vₛₛ). In one exemplary embodiment, voltage levels of Vₛₛ≈0.1V and V_{nbias}=0V may be used.

A number of CMOS inverter circuits (individually and collectively inverter circuits 400) may form circuit 206 in device 200 of FIG. 2.

In operation, inverter circuit 400 also accepts input voltage associated with a digital logic (V_{DD} or Vₛₛ depending on whether the input logic is high or low respectively) via its input node 424 and outputs at its output node 410, an output voltage associated with a complement or inverse of the input logic. A voltage level of high (V_{DD}) supplied at input node 424 causes the voltage level at output node 410 to be low (Vₛₛ). Conversely, a low voltage (Vₛₛ) at input node 124 causes output node 410 to be high (V_{DD}).

The potential difference between the lower-voltage rail potential (Vₛₛ) and the body biasing voltage (V_{nbias}) is adjustable. The potential difference Vₛₛ−V_{nbias} may be thus varied by adjusting Vₛₛ supplied to source terminal 418 of transistor 404.

Transistor 404 may be a low threshold transistor. This helps reduce the signal propagation delay in circuit 400. However, as noted above, this may also lead to increased static power dissipation.

Accordingly, in device 200 of FIG. 2, in which circuit 206 may be formed of inverter circuits 400, controller 202 may reduce leakage current and static power dissipation by adjusting the lower-voltage rail voltage to a higher voltage level V′ₛₛ (that is, V′ₛₛ>Vₛₛ>V_{nbias}), to place circuit 206 in a low power state. For example, the voltages settings V′ₛₛ=0.5V, Vₛₛ=0.1V and V_{nbias}=0V may be used.

As suggested in equation [2], leakage current may flow between the source and drain terminals even after the gate-to-source voltage V_{gs} falls below the threshold voltage Vₜₙ. In addition, the leakage current increases exponentially with (V_{gs}−Vₜₙ).

However, the effective threshold value Vₜₙ of transistor 404 can be controlled by adjusting the voltage supplied to source terminal 418 of n-channel FET 404, to vary the source-to-body potential. When controller 202 adjusts the lower-voltage rail voltage from Vₛₛ to V′ₛₛ, the source-to-body potential difference in n-channel FET 404 correspondingly changes from (Vₛₛ−V_{nbias}) to (V′ₛₛ−V_{nbias}). This in turn affects the effective threshold value Vₜₙ as shown in equation [4] below.

Vₜₙ=Vₜₙ₀+γ(\sqrt{φₛ+(V′ₛₛ−V_{bias})}−\sqrt{φₛ}) [4]

where γ is the body effect coefficient, φₛ is the surface potential and Vₜᵣ₀ is the threshold-voltage when source terminal 418 is at the same potential as body contact 422 (i.e., when V′_{SS}=V_{nbias}).

As can be appreciated, increasing the source terminal voltage of transistor 404 increases its effective threshold value Vₜₙ as shown in equation [4]. The resulting increased effective threshold voltage decreases the leakage current as suggested in equation[2]. Thus transistor 404 will conduct a reduced amount of leakage current when its source terminal potential is lowered with respect to its body potential (substrate potential), and this reduces static power dissipation in circuit 400 when in a low power state (i.e., when source terminal 418 is set to V′ₛₛ).

Advantageously, in operating circuit 400 as described above, propagation delays may be reduced while both dynamic power consumption and static power dissipation (in a low power state) are reduced. Dynamic power consumption is reduced in circuit 400 as a consequence of the lower-voltage rail supply voltage V_{SS}. As the rail-to-rail or dynamic range V_{DD}−V_{SS} is now narrowed (that is, V_{SS}≈0.1V and V_{DD}=1.0V in contrast to FIG. 1 in which V_{SS}=0V and V_{DD}=1.0V). The reduced absolute supply voltage difference |V_{DD}−V_{SS}| leads to lower power dissipation.

In a low power state, static power dissipation is reduced by increasing the voltage supplied to source terminal 418 (e.g., V′_{SS}=0.5V) while back contact 420 is maintained at V_{nbias} (e.g., V_{nbias}=0V). As may be apparent, this increases the effective threshold Vₜₙ for transistor 404 and helps reduce leakage current.

In yet another embodiment of the present invention, the back contacts of both the p-channel and n-channel FETs of the exemplary inverters may be connected to their own corresponding separate body biasing voltage sources, separate from the power supply rails. Accordingly, FIG. 5 shows a CMOS inverter circuit 500 exemplary of another embodiment of the present invention. Inverter circuit 500 includes a p-channel FET 502 interconnecting an n-channel FET 504. The drain terminal 506 of p-channel FET 502 is interconnected to the drain terminal 508 of n-channel FET 504 to form the output node 510. The gate terminal 512 of p-channel FET 502 and interconnects the gate terminal 514 of n-channel FET 504 to form a common input node 524. The source terminal 516 of p-channel FET 502 is interconnected to a higher-voltage rail of an adjustable power supply source (e.g. power supply source 210 in FIG. 2) providing a supply voltage V_{dd}. Lower-voltage rail 216 of power supply source 210 interconnects the source terminal 518 of n-channel FET 504, providing a voltage level of V_{SS}.

Back contact 520 is connected to its own biasing voltage source supplying a fixed biasing voltage V_{pbias}. Similarly back contact 522 is connected to its own biasing voltage source supplying a biasing voltage V_{nbias}.

FIG. 6 further depicts a cross-sectional view of a triple-well structure for inverter circuit 500. Drain terminals 506′, 508′, gate terminals 512′, 514′, source terminal 516′, 518′ and back contacts 520′, 522′ are the same as their counterparts in FIG. 5—they are denoted with a prime (′) symbol in FIG. 6 to distinguish them from FIG. 5 for notational convenience.

As shown, inverter 500 is formed in a p-type substrate 602. The p-channel FET is formed in an n-well 604. The n-channel FET is formed in a p-well 608 which is itself formed inside a deep n-well 606. The p+ region 610 allows back contact 522′ to bias the body (p-well 608) of n-channel FET 504. The n+ region 620 allows back contact 520′ to bias the body (n-well 604) of p-channel FET 502. Additional guard rings may be required to isolate inverter 500 from rest of the logic.

Source terminal 518′ interconnects n+ region 612, while drain terminal 508′ interconnects n+ region 614. Source terminal 516′ interconnects p+ region 618 while drain terminal 506′ interconnects p+ region 616. The steps involved in forming CMOS circuits using a triple-well process are well known in the art. However, the triple-well structure as shown in FIG. 6 is only exemplary and other structures and processes may be used to realize embodiments of the present invention.

A number of CMOS inverter circuits (individually and collectively inverter circuits 500) shown in FIG. 5 may be used to form circuit 206, in device 200 in FIG. 2.

In operation, to reduce dynamic power consumption, power supply source 210 under the control of controller 202 may supply a low voltage level V_{dd} (that is, V_{dd}<V_{DD}) through the higher-voltage power supply rail. For example, in a particular embodiment, a power supply voltage V_{dd}≈0.9V and biasing voltage V_{pbias}=1.0V may be used. In addition, power supply source 210 under the control of controller 202, may also provide voltage level Vₛₛ≈0.1V to the lower-voltage power supply rail, to further reduce dynamic power consumption. A biasing voltage of V_{nbias}=0V may be used.

As shown in equation [1] using a reduced dynamic range for the rail-to-rail voltage difference V_{dd}−Vₛₛ in inverter circuit 500, substantially decreases the dynamic power consumption of circuit 500, compared to the dynamic power consumption of inverter circuit 100 of FIG. 1.

To reduce the propagation delay in inverter circuit 500, low threshold transistors 502, 504 may be used. To mitigate the resulting potential increase in leakage current, (caused by low threshold values) body biasing voltages are applied to the bodies of n-channel FET 504 and p-channel FET 502.

Accordingly, controller 202 (FIG. 2) may adjust the lower-voltage rail voltage to V′ₛₛ=0.3V to place circuit 206 (formed of inverter circuits 500) in a low power state. Thus in one specific embodiment, voltage settings of V′ₛₛ=0.3V, Vₛₛ=0.1V and V_{nbias}=0V may be used. When the voltage at source terminal of 518 n-channel FET 504 is adjusted to V′ₛₛ the source-to-body potential (V′ₛₛ−V_{nbias}) increases (since V′ₛₛ>Vₛₛ) and the effective threshold voltage of n-channel FET 504 also increases in accordance with equation [4]. Consequently, leakage current in transistor 504 is reduced, which in turn reduces static power dissipation when circuit 500 is in a low power state.

The voltage supplied to source terminal 516 may also be decreased (e.g., V′_{dd}≈0.7V) when circuit 500 is placed in a low power state, while back contact 520 is maintained at V_{pbias} (e.g., V_{pbias}=1.0V). Again this increases the effective threshold of transistor 502 and further reduces the leakage current.

As noted above, signal propagation delays are small in circuits that make use of low threshold transistors. Accordingly, in yet another embodiment of the present invention, larger multi-threshold circuit may be realized from a mixture of low threshold transistors. For example, a first set of low threshold transistors may be used in most of the circuit while a second set of very low threshold transistors (with a lower threshold voltage than for those in the first set) may be used in critical delay-sensitive paths to reduce propagation delay.

Further propagation delay reductions may be carried out using multiple sets of transistors with each set having transistors with a distinct threshold-voltage. In other words, M sets of p-channel FETs each having a distinct threshold voltage (Vₜₚ₁, Vₜₚ₂ . . . V_{tpM}) and K sets of n-channel FETs each having a distinct threshold voltage (Vₜₙ₁, Vₜₙ₂ . . . V_{tnK}) may be used to realize larger multi-threshold circuits using inverter circuit 500 or other similar combinational/sequential circuits as a building block.

Advantageously, circuits exemplary of embodiments of the present invention need not adjust body biasing voltages V_{nbias}, V_{pbias}. Instead, only the power supply rail voltages need to be adjusted while leaving biasing voltages V_{nbias}, V_{pbias} unchanged. In other words, the lower-voltage rail may be changed between Vₛₛ and V′ₛₛ or the higher-voltage supply rail voltage may be alternated between V_{dd} and V′_{dd} to achieve dynamic and static power reduction. As power supply rails present a lower resistance than the substrate, power dissipated in adjusting the supply rail voltages (between V_{dd} and V′_{dd} or between Vₛₛ and V′ₛₛ) is less than the power that would have been dissipated if the body biasing voltages were adjusted. Adjusting voltage levels supplied to the back contacts would entail greater power dissipation.

In circuit 300 as shown in FIG. 3, only the supply voltage provided to source terminal 316 of p-channel FET 302 is adjusted (between V_{dd} and V′_{dd}) while keeping V_{SS} fixed. This may be particularly advantageous during device fabrication. As shown in FIG. 6, only a twin-well is required to form a p-channel FET with a separate body biasing voltage and adjustable power supply voltage. This contrasts sharply with a triple-well process that may be needed to form the n-channel FET. Biasing the substrate body of the n-channel FET (FIG. 6) involves setting the voltage of p-substrate 602 to a different potential than the potential of p-well 608 of the n-channel FET. This requires forming a deep n-well 606 to isolate p-substrate 602 from p-well 608. However, in circuit 300 back contact 322 and source terminal 318 of n-channel FET 304 are at the same potential and thus a deep n-well need not be formed.

In another exemplary embodiment, a device may include individually powered circuits called voltage-islands. Each voltage-island may contain one or more circuits, each like circuit 300, circuit 400, or circuit 500 (as shown in FIG. 2). Each voltage island may be provided with an independently controllable supply voltage and a biasing voltage. To that end, each voltage-island may have, or be in communication with, its own controllable power supply and biasing voltage source—or alternately, a common controller may determine the supply voltage and fixed bias voltage levels provided to individual voltage-islands. Accordingly, each voltage-island's biasing voltage or supply voltage may be independently adjusted to reduce both dynamic and static power dissipation in the voltage-island as described. As power may be supplied to each voltage-island independently, the device may have multiple power states instead of just two (i.e., a normal state and a low power state).

Advantageously, embodiments of the present invention are not limited to metal oxide semiconductor (MOS) circuits, but may also be used in Silicon-Germanium (SiGe), Silicon-On-Insulator (SOI), Gallium Arsenide (GaAs) circuits and the like.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. A method of operating an integrated circuit, said circuit comprising:
a p-channel field effect transistor (FET) and n-channel FET formed in a substrate, each of said p-channel FET and n-channel FET comprising a gate, a source, and a drain, at least one of said FETs further comprising a back contact in said substrate, said drain of said p-channel FET interconnecting said drain of said n-channel FET, said method comprising:
providing a fixed bias voltage to said back contact to bias a body of said at least one of said FETs;
applying a supply voltage independent of said fixed bias voltage to a source of said at least one of said FETs at a first voltage level when said circuit is in a normal state; and
applying said supply voltage at a second voltage level when said circuit is in a low power state; said second voltage level lower than said first level when said at least one of said FETs is said p-channel FET and higher than said first level when said at least one of said FETs is said n-channel FET, so as to limit leakage current between said source of said p-channel FET and said source of said n-channel FET.

2. A method of operating an integrated circuit, said circuit comprising:
a p-channel field effect transistor (FET) and n-channel FET formed in a substrate, each of said p-channel FET and n-channel FET comprising a gate, a source, and a drain, said p-channel FET further comprising a back contact in said substrate, said drain of said p-channel FET interconnecting said drain of said n-channel FET, said method comprising:
providing a fixed bias voltage to said back contact of said p-channel FET to bias a body of said p-channel FET;
applying a supply voltage independent of said fixed bias voltage to said source of said p-channel FET at a first voltage level when said circuit is in a normal state; and
applying said supply voltage at a second voltage level lower than said first voltage level when said circuit is in a low power state so as to limit leakage current between said source and said drain of said p-channel FET.

3. A method of operating an integrated circuit, said circuit comprising:
an n-channel field effect transistor (FET) and a p-channel FET formed in a substrate, each of said n-channel FET and p-channel FET comprising a gate, a source, and a drain, said n-channel FET further comprising a back contact in said substrate, said drain of said n-channel FET interconnecting said drain of said p-channel FET, said method comprising:
providing a fixed bias voltage to said back contact of said n-channel FET to bias a body of said n-channel FET;
applying a voltage independent of said fixed bias voltage to said source of said n-channel FET at a first voltage level when said circuit is in a normal state; and
applying said voltage applied to said source of said n-channel FET at a second voltage level higher than said first voltage level when said circuit is in a low power state so as to limit leakage current between said drain and said source of said n-channel FET.

4. The method of claim 2, wherein said n-channel FET further comprises a back contact and said method further comprises applying a second bias voltage to said back contact of said n-channel FET.

5. The method of claim 2, wherein said circuit comprises a plurality of p-channel FETs, at least one of said p-channel FETs having a threshold voltage different from another one of said p-channel FETs.

6. The method of claim 5, wherein said circuit comprises a plurality of n-channel FETs, at least one of said n-channel FETs having a threshold voltage different from another one of said n-channel FETs.

7. The method of claim 3, wherein said supply voltage is provided by a power supply through a higher-voltage rail and a lower-voltage rail, said higher-supply rail interconnecting said source of said p-channel FET.

8. The method of claim 7, wherein said source of said n-channel FET is interconnected directly to said lower-voltage rail.

9. The method of claim 7, wherein said fixed bias voltage is about 0V.

10. The method of claim 9, wherein in said normal state said lower-voltage rail is set to about 0.1V.

11. The method of claim 10, wherein in said low power state, said lower-voltage rail is set to about 0.5V.

12. The method of claim 2, wherein said supply voltage is provided by a power supply through a higher-voltage rail and a lower-voltage rail, said higher-supply rail interconnecting said source of said p-channel FET.

13. The method of claim 12, wherein said source of said p-channel FET is interconnected with said higher-voltage rail.

14. The method of claim 12, wherein said fixed bias voltage is about 1.0V.

15. The method of claim 14, wherein in said normal state, said higher-voltage rail is set to about 0.9V.

16. The method of claim 15, wherein in said low power state, and said higher-voltage rail is set to about 0.5V.

17. A circuit comprising:
(i) a p-channel field effect transistor (FET) formed in an n-well of a p-type substrate, said p-channel FET comprising a gate, source, drain and a back contact for biasing said n-well;
(ii) an n-channel FET formed in a p-well, said p-well formed inside a deep n-well in said substrate, said n-channel FET comprising a gate, source, drain; said gate of said n-channel FET interconnecting said gate of said p-channel FET, said drain of said n-channel FET interconnecting said drain of said p-channel FET;
(iii) an adjustable power supply in communication with a higher-voltage rail interconnecting said source of said p-channel FET and a lower-voltage rail interconnecting said source of said n-channel FET; and
(iv) a biasing voltage source providing a fixed biasing voltage to said back contact of said p-channel FET.

18. The circuit of claim 17, wherein, said power supply provides at said higher-voltage rail:
(i) a first voltage level in a normal state; and
(ii) a second voltage level, lower than said first voltage level in a low power state.

19. The circuit of claim 18, wherein said first voltage level is about 0.9V and said second voltage level is about 0.7V.

20. The circuit of claim 17, wherein said n-channel FET further comprises a back-contact in communication with said p-well, and wherein said biasing voltage source provides said fixed biasing voltage to said back contact of said n-channel FET instead of said back contact of said p-channel FET.

21. The circuit of claim 18, wherein said n-channel FET comprises a back-contact in communication with said p-well, and wherein said circuit further comprises a second biasing voltage source interconnecting said back contact of said n-channel FET to provide a second fixed voltage.

22. The circuit of claim 21, wherein, said power supply provides at said lower-voltage rail:
(i) a third voltage level in a normal state; and
(ii) a fourth voltage level higher than said third voltage level in a low power state.

23. The circuit of claim 22, wherein said third voltage level is about 0.1V and said fourth voltage level is about 0.3V.

24. A device comprising:
(i) an integrated circuit, comprising a p-channel field effect transistor (FET), said p-channel FET comprising a gate, source, drain and back contact terminals formed in a substrate;
(ii) a first bias voltage source providing a first fixed bias voltage to said back contact; and
(iii) a first adjustable supply voltage source interconnected to said source terminal to provide a first supply voltage independent of said first bias voltage;
said device operable in a normal state and a low power state, wherein in said normal state said first supply voltage source provides said first supply voltage at a first voltage level; and in said low power state said first supply voltage source provides said first supply voltage at a second voltage level, lower than said first level, so as to limit leakage current through said p-channel FET in said low power state.

25. The device of claim 24, further comprising:
(i) an n-channel FET comprising a gate, source, drain and back contact terminals formed in a said substrate; said n-channel FET in communication with said p-channel FET;
(ii) a second bias voltage source providing a second fixed bias voltage to said back contact of said n-channel FET; and
(iii) a second adjustable voltage source interconnected to said source terminal of said n-channel FET providing a second supply voltage independent of said first and second biasing voltages,
wherein in said normal state said second supply voltage is at a third voltage level, and in said low power state said second supply voltage is at a fourth voltage level higher than said third level so as to limit leakage current through said n-channel FET in said low power state.

26. A device comprising a plurality of voltage-islands, each of said voltage-islands comprising the circuit of claim 17.
